(19) United States
(12) Patent Application Publication
(10) Pub. No.: US 2014/0300268 A1
(43) Pub. Date: Oct. 9, 2014

(54) INTEGRATED WIRING LED APPARATUS

(71) Applicant: WAITRONY OPTOELECTRONICS LIMITED, Tsuen Wan (CN)

(72) Inventor: Khok Hing-wai, Hong Kong (CN)

(73) Assignee: Waitrony Optoelectronics Limited, Tsuen Wan (CN)

(21) Appl. No.: 13/858,023

(22) Filed: Apr. 6, 2013

(51) Int. Cl. H05B 33/06

(52) U.S. Cl. CPC H05B 33/06
USPC 313/292

(57) ABSTRACT

An Integrated Wiring LED apparatus, which comprises a set of stabilizing winged folding tabs, as well as a set of receiving platforms forms a first and second electrical coupling means formed integrally with the supporting legs of the LED apparatus. Both the first and second electrical coupling means (i.e., the winged folding tabs, and receiving platforms, respectively) are each formed integral to each of the supporting legs 20, and hence each form a unitary structure with each supporting leg structures which connect to the LED body. This integral winged and platform structure are adapted and configured such that electrical conductive wires can be connected on the supporting legs easily and the position of the wires can be fixed firmly, which has advantages of greatly reducing the labor and material cost and manufacturing cost.

### FIELD OF INVENTION

The present disclosure relates generally to light emitting diodes (LED's) and, more particularly, to a LED apparatus with integrated wiring.

### BACKGROUND

When the installation of Light Emitting Diodes (LED) are not on Printed Circuit Board (PCB) but on other locations, such as on a plastic housing, wiring connection should be used to connect the supporting legs of the LED to the PCB or directly to other devices. There are two traditional methods for wiring connections.

FIG. 1 illustrates one of the traditional methods for a LED wiring connection 100 known in the prior art. The LED wiring connection 100 shown in FIG. 1 illustrates a basic structure comprising a LED body 1, conventional supporting legs 2 of the LED body 1, wires 3 and connecting joints 4 for soldering or welding. The wires 3 are connected to the supporting legs 2 of LED body 1 by soldering or welding to form a connecting joint 4. The disadvantage of this connection method is that since the width of the supporting legs of the LED body are usually thin, positioning for the wires on the supporting legs of the LED body is a difficult and time consuming task wasting manpower and labor cost. Moreover, after soldering, positioning the wires such that they are not easily broken during production operation is a problem.

FIG. 2 illustrates another conventional method for LED wiring connection 200 known in the prior art. The LED wiring connection 200 shows a basic structure comprising a LED body 1, conventional supporting legs 2 of LED body 1, wires 3, connecting joints 4 for soldering or welding, lead frames 5 with wings 6 and plastic casing 7. The wires 3 are connected to the lead frames 5 by soldering or welding to form a connecting joint 4. The wings 6 are turned to press the wires from both sides in order to fix the position of wires 3. The lead frames 5 with soldered wires 3 are put into the plastic casing 7. The plastic casing 7 is used for holding the lead frames 5. Finally the supporting legs 2 of the LED body 1 is inserted into the plastic casing 7 to make a connection. An advantage of this configuration is that the width of the lead frames 5 are wider than the supporting legs 2 of LED body 1 thus making it easier for the step of positioning the wire for soldering, and there are the wings 6 to fix the position of the wires such that it will not be easily broken during production of the LED. However, the disadvantage of this configuration is that there are extra materials, such as the lead frames 5 and plastic casings 7, which in turn increases the materials cost and the operational cost.

The above-mentioned conventional methods are lacking in that although the wires can be connected to the supporting legs of the LED body, the first method illustrated in FIG. 1, is difficult for positioning the wires for soldering, and the wires are easy to be broken because of the non-stationary position of the wires causing increased labor costs. And as mentioned above, the method illustrated by FIG. 2 includes both increased material and overall production costs.

Accordingly, there is a need to overcome such lacking methods described above by a simplistic design that can be easily reproduced with readily obtainable materials.

### SUMMARY OF THE INVENTION

The present invention addresses the above-described deficiencies and others. Specifically, this invention can overcome the problems in the prior LED wiring connection by combining the advantages of the first and second methods of FIG. 1 and FIG. 2 respectively together and at the same time to eliminate those disadvantages.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

The novel features which are characteristic of the invention, as to organization and method of use, together with further objects and advantages thereof, will be better understood from the following disclosure considered in connection with the accompanying drawings in which one or more preferred embodiments of the invention are illustrated by way of example. It is to be expressly understood, however, that the drawings are for the purpose of illustration and description only and are not intended as a definition of the limits of the invention.

As used herein, the term “comprises” refers to a part or parts of a whole, but does not exclude other parts. That is, the term “comprises” is open language that requires the presence of the recited element or structure or its equivalent, but does not exclude the presence of other elements or structures. The term “comprises” has the same meaning and is interchangeable with the terms “includes” and “has”. The term set has the meaning of one or more of said element. Furthermore, any use of the term “or” as used herein is generally intended to mean “and/or” unless otherwise indicated. Combinations of components or steps will also be considered as being noted, where terminology is foreseen as rendering the ability to separate or combine is unclear.

### BRIEF DESCRIPTION OF THE DRAWINGS

Embodiments of the present disclosure are described herein with reference to the drawings, in which:

FIG. 1 is a diagram of a simple LED wiring connection method known in the prior art;

FIG. 2 is a diagram of another conventional LED wiring connection method known in the prior art;

FIG. 3 is a diagram of the design of Integrated Wiring LED of the present disclosure prior to wire connection; and

FIG. 4 is a diagram of the design of Integrated Wiring LED of the present disclosure illustrating wire connections.

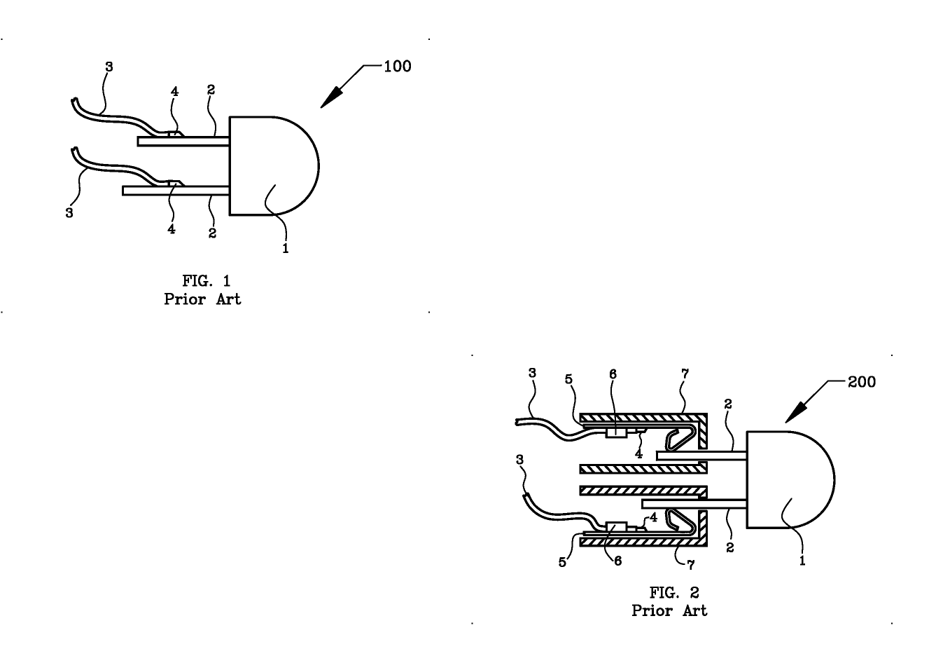

### DETAILED DESCRIPTION

The instant invention solves the aforementioned deficiencies in the prior art and provides structural solutions to the LED device, which facilitates positioning of conductive wires for soldering. As illustrated and discussed below, the wires are fixed properly to prevent it from being easily broken during manufacturing, and provides for a more durable LED device.

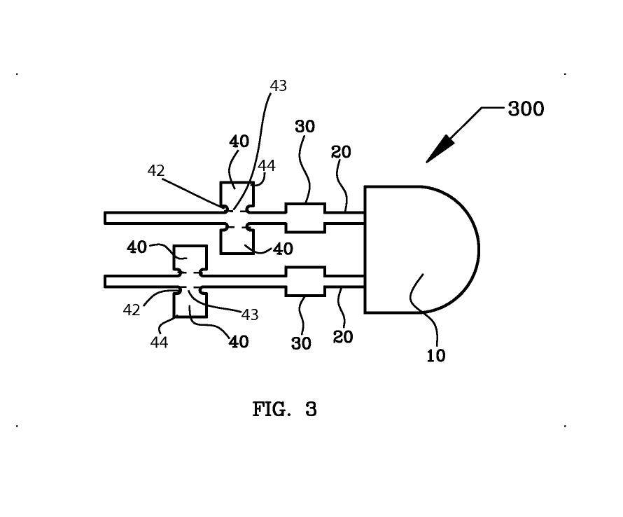

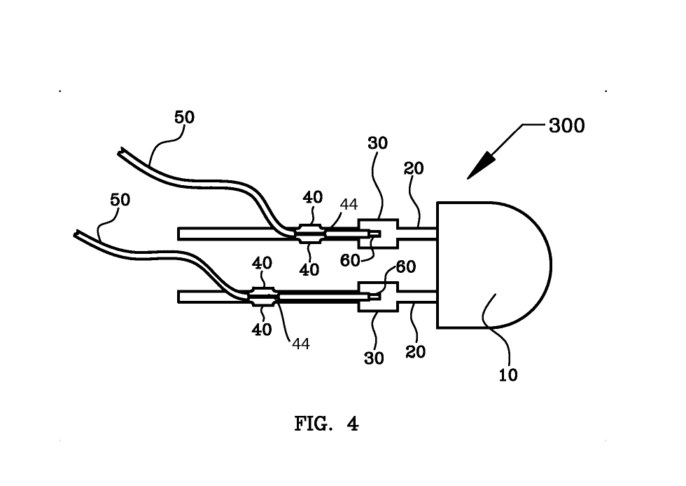

FIG. 3 and FIG. 4 illustrate a novel structure of an Integrated Wiring LED 300 that comprises the advantages of the above-mentioned traditional LED wiring connection of the prior art with improved structural design considerations. FIG. 3 is a diagram of the instant invention prior to electrical connection to conductive wires, while FIG. 4 is diagram of the instant invention illustrating electrical wire connection.

The integrated wiring LED assembly 300 comprises at least one light emitting diode circuit, for emitting light, which is conventionally encapsulated within a transparent housing and forming a LED body 10. The integrated wiring LED assembly 300 has a set of at least two partially conductive supporting leg frames 20 for providing an electrical connection means between the LED circuitry housed within LED body 10 and an electrical power source and/or control signal (not shown). Each of the conductive supporting leg frames 20 have a first and second electrical coupling means for facilitating connection between electrical conductive wires 50 and said supporting leg frames 20.

The first electrical coupling means comprises a set of winged folding tabs 40 which are formed integral to the structure of the supporting legs 20 and located on a longitudinal axis along each of the supporting legs. The winged folding tabs 40 each have a set of fold indents 42 which form a structural fold line 43 (indicated in phantom) and are located centrally relative to the distal ends 44 of the winged folding tabs 40. As seen in FIG. 4, conductive wires 50 are encased within said winged folding tabs 40 for stabilizing the wires and keeping them in a stationary position. The winged folding tabs 40 are fold toward one another being substantially adjacent one another when encasing and holding the conductive wires 50 in place.

The second electrical coupling means comprises a receiving platform 30, which is formed integral to the supporting leg 20 and is also located on a longitudinal axis along each of the supporting legs 20. Since the receiving platform 30 serves as an electrical connection node for the tip 60 of the electrical conductive wires 50, the receiving platform 30 is comprised at least partially of electrically conductive material. Both the first and second electrical coupling means (i.e., the winged folding tabs 40, and receiving platforms 30, respectively) are each formed integral to each of the supporting legs 20, and hence each form a unitary structure with each supporting leg 20, as can be seen in FIG. 3.

The distance between the first electrical coupling means 40 and the second electrical coupling means 30 on the first supporting leg 20 is defined by D1. The distance between the first electrical coupling means and the second electrical coupling means on the second supporting leg 20 is defined by D2. And wherein, D1 is not equal to D2 [D1≠D2], which provides for the respective first electrical couple means to have a different pitch from one another; therefore, each of the winged folding tabs 40 are offset spatially from one another in that the they are each a different distance from the respective second electrical coupling means, i.e., receiving platforms 30. The tips 60 of the conductive wires 50 may be soldered or welded, as is known in the art, for electrically connecting said wire to the support legs 20, and thus subsequently providing electrical power and/or control signal to the LED circuit.
Several advantages of this new design include the following:
   The receiving platforms 30 may be wider than the width of the supporting legs 20. This facilitates positioning of the wires 50 for tin soldering or welding to form better electrical connections at tips 60.
   The receiving platforms 30 form an integral part of the supporting legs 20 extending from the LED body 10 so there is no further insertion or connection during the manufacturing process.
   The winged folding tabs 40 are used to fix the position of the wires 50 such that the wires 50 will not be easy to be broken during production operations.
   The winged folding tabs 40 also form an integral part of the supporting legs 20 so there is no further insertion or connection during the manufacturing process.

This invention can apply to all kinds of LED's, and the LED may be a conventional pin package having two or more supporting legs. Moreover, beyond LED's, this inventive concepts of the instant invention may be employed on other optical devices such as an optoelectronic device selected from the group consisting of light emitting diodes, photodiodes, phototransistors, light sensors, reflective sensors, photo interrupters, and receiver modules and furthermore this invention can apply to any kinds of electronic components with supporting legs.

It is to be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform or assist with any of the methods and procedures for manufacturing the apparatus described herein.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used and/or to the particular embodiment disclosed as the best mode contemplated for carrying out this invention, but that the invention will include any and all embodiments and equivalents falling within the scope of the instant disclosure.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

What is claimed is:

1. A light emitting diode apparatus, comprising:
at least one light emitting diode (LED) circuit, for emitting light,
said LED circuit encapsulated within a transparent housing and forming a LED body;
said LED body coupled to at least a first and second supporting leg frames, wherein
each of said supporting leg frames being at least partially electrically conductive, and having a first and a second electrical coupling means integral with each of said supporting leg frames for providing electrical connection between said LED circuit and an electrical power source and/or control signal.

2. The light emitting diode apparatus of claim 1,
wherein said first electrical coupling means comprises a stabilizing winged folding tab having opposing flaps for at least partially encasing electrical conductive wires in a stationary manner; and
wherein said second electrical coupling means is at least partially comprised of electrically conductive material and comprises a receiving platform for providing an electrical connection node for said electrically conductive wires.

3. The light emitting diode apparatus of claim 2,
wherein said receiving platform having a substantially planar connecting surface.

4. The light emitting diode apparatus of claim 3,
wherein said winged folding tab has a set of fold indents providing a fold line centrally located relative to the distal ends of said opposing flaps for folding about and encasing said electrical coupling wires when said opposing flaps are folded into each other in a closed position, and
wherein said first coupling means is adapted and configured to have a first open winged position located within the same longitudinal plane of the supporting leg frame when in a electrically disconnected state, and
wherein said first coupling means is adapted and configured to have a second closed position when encasing said electrical conductive wire, said closed position comprises said first and second opposing flaps being substantially adjacent one another, and located in a plane perpendicular to the supporting leg frame.

5. The light emitting diode apparatus of claim 4,
wherein the distance between the first coupling means and the second coupling means along the longitudinal axis of the supporting leg is defined by a first distance, and the distance between the first coupling means and the second coupling means along the longitudinal axis of the second supporting leg is defined by a second distance, and wherein said first and second distance are not equal such that the first coupling means of each supporting leg are offset spatially from one another.

6. The light emitting diode apparatus of claim 5,
wherein said first distance is less than said second distance, such that the first coupling means of each supporting leg are offset spatially from one another.
